(19) United States
(12) Patent Application Publication
(10) Pub. No.: US 2025/0149549 A1
(43) Pub. Date: May 8, 2025

(54) METHOD OF PREPARING ANODE COMPOSITION AND METHOD OF FABRICATING ANODE USING THE SAME

(71) Applicant: SK ON CO., LTD., Seoul (KR)

(72) Inventor: Seon Jin KIM, Daejeon (KR)

(21) Appl. No.: 18/925,020

(22) Filed: Oct. 24, 2024

(30) Foreign Application Priority Data
Nov. 7, 2023 (KR) 10-2023-0152858

(51) Int. Cl. H01M 4/36; H01M 4/02; H01M 4/04; H01M 4/1393; H01M 4/587; H01M 4/62; H01M 10/0525

(52) U.S. Cl. CPC H01M 4/364; H01M 4/0404; H01M 4/043; H01M 4/1393; H01M 4/587; H01M 4/622; H01M 10/0525; H01M 2004/027

(57) ABSTRACT

In a method of preparing an anode composition, a first graphite-based active material and a first binder are mixed to form a first mixture. A second graphite-based active material different from the first graphite-based is mixed with a second binder different from the first binder to form a second mixture. The first mixture and the second mixture are mixed to form an anode composition.

### CROSS-REFERENCE TO RELATED APPLICATION AND CLAIM OF PRIORITY

This application claims priority to Korean Patent Application No. 10-2023-0152858 filed on Nov. 7, 2023 in the Korean Intellectual Property Office (KIPO), the entire disclosure of which is incorporated by reference herein.

### TECHNICAL FIELD

The disclosure of this patent application relates to a method of preparing an anode composition and a method of fabricating an anode using the same. More particularly, the disclosure of this patent application relates to a method of preparing an anode composition including an anode active material and a binder and a method of fabricating an anode using the same.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source of an electric automobile, a hybrid vehicle, etc.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

The lithium secondary battery may include an electrode assembly including repeatedly stacked cathodes and anodes, and an electrolyte impregnating the electrode assembly. The lithium secondary battery may further include an outer material, e.g., in the form of a pouch, for housing the electrode assembly and the electrolyte.

To prepare the anode, an anode active material such as a graphite-based active material and a conductive material may be dispersed in a solvent together with a binder to form an anode slurry. The anode slurry may be coated on an anode current collector, and then dried and pressed to obtain the anode.

In the anode slurry, the binder and the anode active material may not be sufficiently bound to each other, and an agglomeration of the binder may occur. In this case, non-uniformity in a thickness and a density of the anode may occur, and capacity properties may also be lowered.

### SUMMARY

According to an aspect of the present disclosure, there is provided an anode composition having improved mechanical and electrochemical stability.

According to an aspect of the present disclosure, there is provided a method of fabricating an anode using the anode composition.

According to an aspect of the present disclosure, there is provided a lithium secondary battery including the anode and a method of fabricating the lithium secondary battery.

In a method of preparing an anode composition, a first graphite-based active material and a first binder are mixed to form a first mixture. A second graphite-based active material different from the first graphite-based is mixed with a second binder different from the first binder to form a second mixture. The first mixture and the second mixture are mixed to form an anode composition.

In some embodiments, the first graphite-based active material may include artificial graphite, and the second graphite-based active material may include natural graphite.

In some embodiments, the first binder may include a cellulose-based binder, and the second binder includes a butadiene rubber-based binder.

In some embodiments, the first binder may include carboxymethyl cellulose (CMC) and the second binder may include styrene-butadiene rubber (SBR).

In some embodiments, the first mixture comprises may be formed by dry-mixing the first graphite-based active material and a powder of the first binder.

In some embodiments, the second mixture may be formed by mixing the second graphite-based active material and a solution of the second binder.

In some embodiments, a content of the first binder may be in a range from 0.1 wt % to 2 wt % based on a total weight of the first mixture.

In some embodiments, a content of the second binder may be in a range from 1 wt % to 7 wt % based on a total weight of the second mixture.

In some embodiments, in the formation of the anode composition, the first mixture, the second mixture and a conductive material may be mixed to form a third mixture. The third mixture may be mixed with a solution of the first binder.

In some embodiments, the third mixture may be formed by dry-mixing the first mixture, the second mixture and the conductive material, each of which may have a powder form.

In some embodiments, the second mixture may have a powder form having an increased liquid content compared to that of the first mixture.

In some embodiments, the third mixture may have a powder form having a reduced liquid content compared to that of the second mixture.

In some embodiments, a solid content of the anode composition may be in a range from 40 wt % to 70 wt %.

In some embodiments, a viscosity of the anode composition may be in a range from 20 Pa·s to 40 Pa·s at 25° C.

In a method for fabricating an anode, the above-prepared anode composition is coated on an anode current collector. The coated anode composition is dried and pressed to form an anode active material layer.

In some embodiments, an adhesive force between the anode current collector and the anode active material layer may be 0.1 N/cm or more.

In some embodiments, an adhesive force between the anode current collector and the anode active material layer may be in a range from 0.15 N/cm to 0.5 N/cm.

In a method for manufacturing a lithium secondary battery, an anode is prepared according to the above-described method. A cathode is prepared. The cathode and the anode are repeatedly stacked.

In some embodiments, the anode active material layer of the anode may include artificial graphite and natural graphite as a graphite-based active material, and may include a cellulose-based binder and a butadiene rubber-based binder as a binder.

According to the embodiments of the present disclosure, a first mixture and a second mixture may be prepared by pre-mixing a first graphite-based active material and a second graphite-based active material with a first binder and a second binder, respectively. Thereafter, the first and second mixtures may be mixed to obtain an anode composition, e.g., in the form of a slurry.

The different graphite-based materials and binders may be pre-mixed in advance and then post-mixed, so that binding strength/dispersibility between the binders and the graphite-based materials may be sufficiently obtained. Thus, a binder migration in an electrode drying process may be prevented while also preventing aggregation of the binder.

Thus, the anode and the lithium secondary battery using the anode composition may provide a stable adhesion of the active material layer by the binder and uniform capacity properties.

The anode and the lithium secondary battery of the present disclosure may be widely applied in green technology fields such as an electric vehicle, a battery charging station, a solar power generation, a wind power generation, etc., using a battery, etc. The anode and the lithium secondary battery according to the present disclosure may be used for eco-friendly electric vehicles and hybrid vehicles to prevent a climate change by suppressing air pollution and greenhouse gas emissions. etc.

### BRIEF DESCRIPTION OF THE DRAWINGS

FIG. 1 is a flow diagram for describing a method of preparing an anode composition in accordance with example embodiments.

FIG. 2 is a flow diagram for describing a method of preparing an anode composition in accordance with a comparative example.

FIG. 3 and FIG. 4 are schematic diagrams illustrating interaction/binding forms of active materials, conductive materials and binders according to a comparative example and an example embodiment, respectively.

FIG. 5 is a schematic cross-sectional view illustrating an anode in accordance with example embodiments.

FIG. 6 and FIG. 7 are a schematic plan view and a schematic cross-sectional view, respectively, illustrating a lithium secondary battery in accordance with example embodiments.

### DETAILED DESCRIPTION OF THE EMBODIMENTS

According to embodiments of the present disclosure, a method for preparing an anode composition using different active materials and different binders is provided. According to embodiments of the present disclosure, a method for fabricating an anode using the anode composition is provided. According to embodiments of the present disclosure, an anode and a lithium secondary battery fabricated using the anode composition are provided.

Hereinafter, the present disclosure will be described in detail with referenced to the attached drawings and example embodiments. However, those are merely provided as examples and the present disclosure is not limited to the specific embodiments disclosed herein.

The terms “first”, “second”, “upper”, “lower”, etc., herein are used relatively to distinguish different elements, positions, etc., and do not limit absolute positions, orders, etc. The term “anode composition” herein is used to encompass the form of a mixture, a dispersion, a slurry, a viscous fluid, etc., formed by mixing an anode active material and a binder.

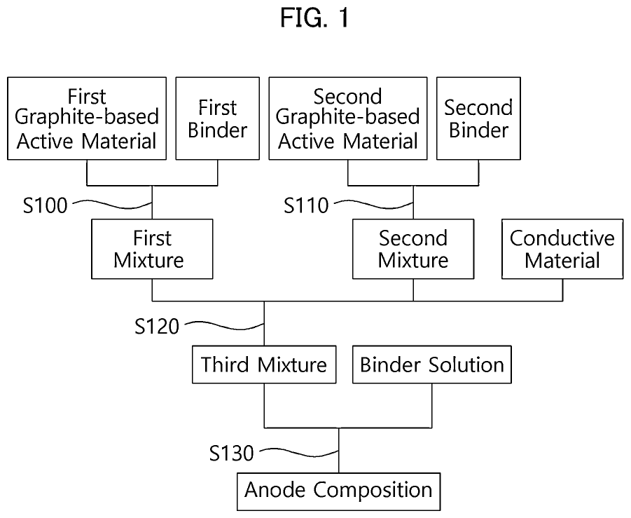

FIG. 1 is a flow diagram for describing a method of preparing an anode composition in accordance with example embodiments.

Referring to FIG. 1, a first mixture and a second mixture may be prepared in, e.g., operations of S100 and S110, respectively.

In example embodiments, a first graphite-based active material and a first binder may be mixed to form the first mixture. A second graphite-based active material and a second binder may be mixed to form the second mixture. The first mixture and the second mixture may be prepared independently and individually from each other.

The first graphite-based active material and the second graphite-based active material may each include artificial graphite and/or natural graphite. In example embodiments, the first graphite-based active material may include artificial graphite, and the second graphite-based active material may include natural graphite. In some embodiments, the first graphite-based active material may substantially consist of artificial graphite, and the second graphite-based active material may substantially consist of natural graphite.

Artificial graphite may have relatively increased chemical/structural stability compared to those of natural graphite. Natural graphite may have relatively improved capacity properties compared to those of artificial graphite. Artificial graphite and natural graphite may be used together to provide life-span properties and capacity stability during repeated charge/discharge, and may effectively implement high capacity properties.

In some embodiments, input amounts of artificial graphite and natural graphite may be adjusted when forming the first mixture and the second mixture, so that a weight ratio of artificial graphite and natural graphite included in the anode composition may be adjusted to a range from 2:8 to 8:2, from 3:7 to 7:3, or from 4:6 to 6:4.

The first binder and the second binder may each include a butadiene rubber-based binder such as acrylonitrile butadiene rubber (NBR), polybutadiene rubber (BR) and styrene-butadiene rubber (SBR), a cellulose-based binder such as carboxymethyl cellulose (CMC), a polyacrylic acid-based binder, a poly(3,4-ethylenedioxythiophene) (PEDOT)-based binder, polyacrylonitrile, polymethylmethacrylate, etc.

In example embodiments, the first binder may include the cellulose-based binder. The second binder may include the butadiene rubber-based binder. In some embodiments, the first binder may include CMC, and the second binder may include SBR. In an embodiment, the first binder may substantially consist of CMC, and the second binder may substantially consist of SBR.

Hereinafter, an example in which artificial graphite and CMC are used as the first graphite-based active material and the first binder, respectively, and natural graphite and SBR are used as the second graphite-based active material and the second binder, respectively, will be described in detail as an embodiment of the present disclosure.

The first mixture may be formed by pre-mixing artificial graphite as the first graphite-based active material and CMC as the first binder (a first pre-mixing). In some embodiments, the first pre-mixing may be performed by a dry mixing, and thus the first mixture may be prepared in the form of artificial graphite-CMC powder.

Artificial graphite may have a relatively strong affinity with CMC to easily interact with CMC. Accordingly, sufficient adhesion between artificial graphite and CMC may be achieved in advance through the first pre-mixing, and desorption of CMC may be prevented. Additionally, artificial graphite and CMC may be adsorbed by the dry mixing, so that aggregation of artificial graphite and CMC which may occur in a solution state may be prevented.

In some embodiments, a content of CMC (the first binder) based on a total weight of the artificial graphite-CMC powder may be in a range from 0.1 wt % to 2 wt %. In an embodiment, the content of CMC (the first binder) based on the total weight of the artificial graphite-CMC powder may be in a range from 0.1 wt % to 1 wt %, from 0.2 wt % to 0.8 wt %, or from 0.3 wt % to 0.7 wt %. In the above range, a pre-adsorption of CMC may be implemented while sufficiently maintaining life-span stability by artificial graphite.

Natural graphite as the second graphite-based active material and SBR as the second binder may be pre-mixed (a second pre-mixing) to form the second mixture. In some embodiments, the second pre-mixing may be performed by a wet mixing. For example, an SBR solution in the form of an aqueous solution may be prepared, and then a natural graphite powder may be mixed into the SBR solution to obtain the second mixture.

In an embodiment, a content of a solvent (e.g., water) based on a total weight of the SBR solution may be in a range from 30 weight percent (wt %) to 80 wt %, from 30 wt % to 70 wt %, or from 40 wt % to 60 wt %.

For example, the second mixture may be prepared in the form of a natural graphite-SBR powder having a higher liquid (for example, moisture) content than that of the first mixture.

Natural graphite has a relatively strong affinity with SBR and may easily interact with SBR. Accordingly, sufficient adhesion between natural graphite and SBR may be achieved in advance through the second pre-mixing, and desorption of SBR may be prevented. Additionally, SBR that may serve as an aqueous binder may be mixed with natural graphite through the wet mixing so that natural graphite and SBR may be pre-adsorbed. Accordingly, excessive aggregation of natural graphite-SBR in the powder state may be prevented.

In some embodiments, a content of SBR (the second binder) based on the total weight of the natural graphite-SBR powder may be in a range from 1 wt % to 10 wt %. In an embodiment, the content of SBR (the second binder) based on the total weight of the natural graphite-SBR powder may be in a range from 1 wt % to 7 wt %, from 2 wt % to 7 wt %, from 2 wt % to 6 wt %, or from 2 wt % to 5 wt %. In the above range, a binding force with natural graphite may be increased while obtaining sufficient adhesion to the current collector by SBR.

For example, in an operation S120, the first mixture and the second mixture may be mixed to form a third mixture. In some embodiments, a conductive material may be mixed together with the first mixture and the second mixture.

In example embodiments, the third mixture may be formed by a dry mixing. The third mixture may be provided as an anode powder having a lower liquid (moisture) content than that in the second mixture.

Accordingly, the conductive material may be dispersed in the mixture while preventing agglomeration and binder separation of the first mixture and the second mixture having the powder forms in a solution state.

When preparing the third mixture, a mixing ratio of the first mixture and the second mixture may be adjusted so that the above-described weight ratio of artificial graphite and natural graphite may be satisfied.

The conductive material may be added in an amount from 0.5 wt % to 10 wt %, from 0.5 wt % to 5 wt %, or from 1 wt % to 3 wt % based on a solid content of the obtained anode composition.

The conductive material may be added to enhance conductivity and/or mobility of lithium ions or electrons. For example, the conductive material may include a carbon-based conductive material such as graphite, carbon black, acetylene black, ketjen black, graphene, a carbon nanotube, a vapor-grown carbon fiber (VGCF), etc., and/or a metal-based conductive material including tin, tin oxide, titanium oxide, a perovskite material such as LaSrCoO₃ and LaSrMnO₃, etc.

In some embodiments, the conductive material may include a carbon-based conductive material except for the graphite-based material such as carbon black, acetylene black, ketjen black, graphene, a carbon nanotube, a carbon fiber, etc.

For example, in an operation S130, the third mixture and a binder solution may be mixed to prepare an anode composition.

In example embodiments, the binder solution may be an aqueous solution of the first binder. In some embodiments, the binder solution may be an aqueous solution of a cellulose-based binder, for example, a CMC aqueous solution.

The third mixture may be introduced into the binder solution, and then stirred using a mixer to form the anode composition, e.g., in the form of a slurry.

In some embodiments, a mixing rate for preparing the anode composition may be greater than a mixing rate (e.g., a stirring speed) for forming each of the above-described first to third mixtures. For example, a stirring speed for mixing the third mixture and the binder solution may be 1,000 rpm or more, e.g., from 1,000 rpm to 3,000 rpm, from 1,500 rpm to 3,000 rpm, or from 1,500 rpm to 2,500 rpm.

The stirring speed for forming each of the first to third mixtures may be 500 rpm or less, e.g., from 50 rpm to 500 rpm, from 50 rpm to 300 rpm, from 50 rpm to 200 rpm, or from 50 rpm to 100 rpm.

As described above, the binder solution containing CMC may be additionally introduced, so that CMC may be uniformly distributed in the natural graphite-SBR assembly. Thus, a uniform viscosity may be achieved throughout the anode composition. Further, the first mixture and the second mixture may be mixed again to a solution phase in a pre-adsorbed state, so that desorption of the binder may be suppressed in the mixing process for preparing the slurry and a binding state of the binder-active material may be maintained.

A solid content of the anode composition may be in a range from 40 wt % to 70 wt %. In the above range, binder migration occurring in a drying process may be reduced or suppressed while maintaining uniform coating properties on the current collector.

In an embodiment, the solid content of the anode composition may be in a range from 45 wt % to 65 wt %, or from 50 wt % to 60 wt %.

A content of the graphite-based active material may be in a range from 85 wt % to 98 wt %, a content of the first binder may be in a range from 0.5 wt % to 5 wt %, a content of the second binder may be in a range from 0.5 wt % to 5 wt % and a content of the conductive material may be in a range from 0.5 wt % to 10 wt % based on the solid content of the anode composition.

In some embodiments, a viscosity of the anode composition may be in a range from 20 Pa·s to 40 Pa·s at 25° C. In an embodiment, the viscosity of the anode composition may be in a range from 20 Pa·s to 35 Pa·s, or from 25 Pa·s to 35 Pa·s.

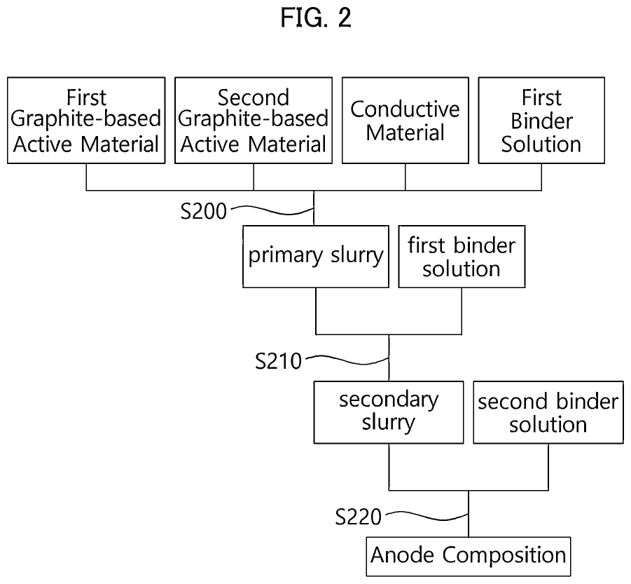

FIG. 2 is a flow diagram for describing a method of preparing an anode composition in accordance with a comparative example. Detailed descriptions on processes and materials substantially the same as or similar to those described with reference to FIG. 1 are omitted.

Referring to FIG. 2, e.g., in an operation S200, a primary slurry may be prepared by mixing a first graphite-based active material (e.g., artificial graphite), a second graphite-based active material (e.g., natural graphite), a conductive material and a first binder solution (e.g., a CMC solution). The primary slurry is formed through wet mixing using the CMC solution.

For example, in an operation S210, the primary slurry may be mixed again with the first binder solution to prepare a secondary slurry having increased dispersibility. Thereafter, an anode composition in the form of a target slurry may be prepared by mixing/stirring the secondary slurry with a second binder solution containing SBR.

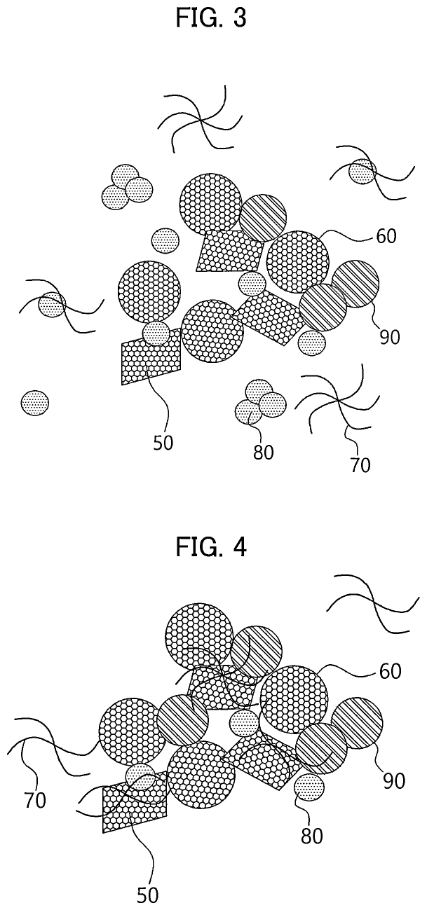

FIG. 3 and FIG. 4 are schematic diagrams illustrating interaction/binding forms of active materials, conductive materials and binders according to a comparative example and an example embodiment, respectively.

Referring to FIG. 3, according to the comparative example described with reference to FIG. 2, a first graphite-based active material 50, a second graphite-based active material 60, and a conductive material 90 may randomly contact each other, and thus a first binder 70 including CMC may not be sufficiently adsorbed to the active materials. Accordingly, the first binder 70 may be desorbed and present in an aggregated pre-binder state.

Further, a second binder 80 including SBR may not be pre-adsorbed with the graphite-based active material, resulting in binder agglomeration, and the second binder 80 may also be present in an agglomerated pre-binder state.

Accordingly, a viscosity of the anode composition of the comparative example may become non-uniform, and the pre-binder may be migrated in a drying process when manufacturing an electrode, thereby further non-uniformly distributing the binder in the anode active material layer.

Referring to FIG. 3, as described in example embodiments with reference to FIG. 1, the artificial graphite-CMC assembly and the natural graphite-SBR assembly may be pre-adsorbed in advance to significantly reduce or suppress the binder aggregation. Additionally, an amount of the first binder 70 or the second binder 80 existing as the pre-binder state in the slurry state may be significantly reduced.

Accordingly, the anode composition may entirely maintain a uniform active material-binder-conductive material distribution state, and may maintain the viscosity within the above-described range. Additionally, when manufacturing the anode, the binder migration may be suppressed in the drying process to increase the adhesive force between the anode current collector and the anode active material layer.

In example embodiments, an amount of the pre-binder not bonded to the active material based on the total weight of the binder included in the anode composition may be 20 wt % or less. In an embodiment, the amount of the pre-binder may be 15 wt % or less, 10 wt % or less, or 5 wt % or less.

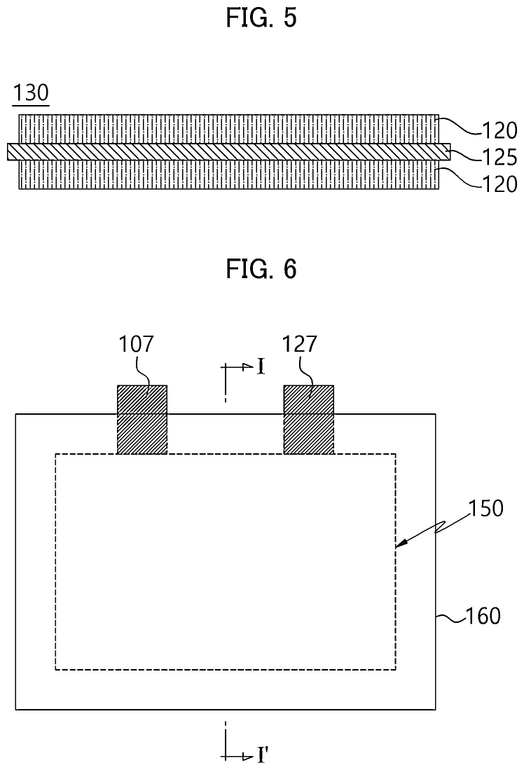

FIG. 5 is a schematic cross-sectional view illustrating an anode in accordance with example embodiments.

Referring to FIG. 5, an anode 130 may include an anode current collector 125 and an anode active material layer 120.

For example, the anode current collector 125 may include copper, stainless steel, nickel, titanium or an alloy thereof. In an embodiment, the anode current collector 125 may include copper or stainless steel surface-treated with carbon, nickel, titanium or silver.

The anode composition according to embodiments of the present disclosure described above may be coated on the cathode current collector 125, and then dried and pressed to form the anode active material layer 120. The anode active material layer 120 may be formed on at least one surface of the cathode current collector 125. In example embodiments, the anode active material layer 120 may be formed on each of an upper surface and a lower surface of the anode current collector 125. The anode active material layer 120 may be in a direct contact with the anode current collector 125.

As described above, the binder migration may be suppressed during the drying process, and thus the anode active material layer 120 may be formed on the anode current collector 125 with a high adhesive force.

In example embodiments, the adhesive force of the anode active material layer 120 to the anode current collector 125 may be 0.1 N/cm or more. In some embodiments, the adhesive force of the anode active material layer 120 to the anode current collector 125 may be 0.15 N/cm or more, and 0.2 N/cm or more. For example, the adhesive force may be in a range from 0.1 N/cm to 0.5 N/cm, from 0.1 N/cm to 0.4 N/cm, from 0.1 N/cm to 0.3 N/cm, from 0.15 N/cm to 0.5 N/cm, from 0.15 N/cm to 0.4 N/cm, from 0.15 N/cm to 0.3 N/cm, from 0.2 N/cm to 0.5 N/cm, or 0.2 N/cm to 0.4 N/cm.

In the above range, a sufficient capacity through the graphite-based active material may be obtained while preventing the anode active material layer 120 from being detached.

The adhesive force of the anode active material layer 120 may be a peeling force measured by fixing an anode sample to a slide glass with a double-sided tape, attaching the measurement tape to a surface of the anode active material layer 120, and then pulling the tape in a condition of 100 mm/min and 90°.

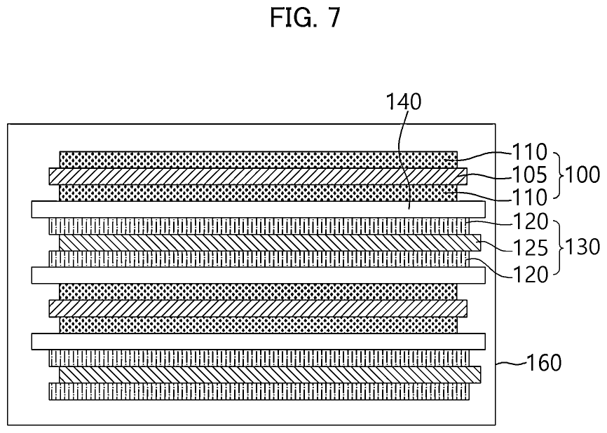

FIG. 6 and FIG. 7 are a schematic plan view and a schematic cross-sectional view, respectively, illustrating a lithium secondary battery in accordance with example embodiments. For example, FIG. 7 is a cross-sectional view taken along line a I-I′ of FIG. 6 in a thickness direction.

A lithium secondary battery illustrated in FIGS. 6 and 7 is schematically provided for convenience of descriptions, and the structure of the lithium secondary battery of the present disclosure is not limited as that illustrated in FIGS. 6 and 7.

Referring to FIGS. 6 and 7, the lithium secondary battery includes the anode 130 including the anode active material layer 120 and the anode current collector 125, and a cathode 100. The lithium secondary battery may further include a separator 140 interposed between the cathode 100 and the anode 130.

The cathode 100 may include a cathode active material layer 110 formed by coating a cathode active material on a cathode current collector 105. The cathode active material may include a compound capable of reversibly intercalating and de-intercalating lithium ions.

The cathode current collector 105 may include stainless steel, nickel, aluminum, titanium or an alloy thereof. The cathode current collector 105 may include aluminum or stainless steel surface-treated with carbon, nickel, titanium or silver.

The cathode active material may include a compound capable of reversibly intercalating and de-intercalating lithium ions.

In example embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Chemical Formula 1 below.

LiₓNiₐM_{b}O_{2+z} [Chemical Formula 1]

In Chemical Formula 1, 0.9≤x≤1.5, 0.6≤a≤0.99, 0.01≤b≤0.4, and −0.5≤z≤0.1. As described above, M may include Co, Mn and/or Al.

The chemical structure represented by Chemical Formula 1 represents a bonding relationship included in the layered structure or the crystal structure of the cathode active material or the lithium-transition nickel metal oxide particle, and does not exclude other additional elements. For example, M includes Co and/or Mn, and Co and/or Mn may serve as a main active element of the cathode active material together with Ni. Chemical Formula 1 is provided to express the bonding relationship of the main active element and is to be understood as a formula encompassing introduction and substitution of the additional elements.

In an embodiment, an auxiliary element for enhancing chemical stability of the cathode active material or the layered structure/crystal structure in addition to the main active element may be further included. The auxiliary element may be incorporated into the layered structure/crystal structure to form a bond, and this case is to be understood as being included within the range of the chemical structure represented by Chemical Formula 1.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al that contributes to capacity/power activity of the cathode active material together with Co or Mn.

For example, the cathode active material or the lithium-transition metal oxide particle may include a layered structure or a crystal structure represented by Chemical Formula 1-1.

LiₓNiₐM1_{b1}M2_{b2}O_{2+z} [Chemical Formula 1-1]

In Chemical Formula 1-1, M1 may include Co, Mn and/or Al. M2 may include the above-described auxiliary element. In Chemical Formula 1-1, 0.9≤x≤1.2, 0.6≤a≤0.99, 0.01≤b1+b2≤0.5, and −0.5≤z≤0.1.

The cathode active material above may further include a coting element or a doping element. For example, elements substantially the same as or similar to the above-described auxiliary elements may be used as the coating element or the doping element. For example, the above-described elements may be used alone or in a combination of two or more therefrom as the coating element or the doping element.

The coating element or the doping element may be present on a surface of the lithium-transition metal oxide particle, or may penetrate through the surface of the lithium-transition metal oxide particle to be included in the bonding structure represented by Chemical Formula 1 or Chemical Formula 1-1.

The cathode active material may include a nickel-cobalt-manganese (NCM)-based lithium oxide. In this case, an NCM-based lithium oxide having an increased nickel content may be used.

Ni may be provided as a transition metal related to the power and capacity of the lithium secondary battery. Thus, as described above, a high-capacity cathode and a high-capacity lithium secondary battery may be implemented using a high-Ni composition in the cathode active material.

However, as the content of Ni increases, long-term storage stability and life-span stability of the cathode or the secondary battery may be relatively lowered, and side reactions with an electrolyte may also be increased. However, according to example embodiments, life-span stability and capacity retention properties may be improved using Mn while maintaining an electrical conductivity by Co.

The content of Ni in the NCM-based lithium oxide (e.g., a mole fraction of nickel based on the total number of moles of nickel, cobalt and manganese) may be 0.6 or more, 0.7 or more, or 0.8 or more. In some embodiments, the content of Ni may be in a range from 0.8 to 0.95, from 0.82 to 0.95, from 0.83 to 0.95, from 0.84 to 0.95, from 0.85 to 0.95, or from 0.88 to 0.95.

In some embodiments, the cathode active material may further include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may further include, e.g., a Mn-rich active material, a Li-rich layered oxide (LLO)/OLO (over-lithiated oxide) active material, or a Co-less active material, etc., which may have a chemical structure or a crystal structure represented by Chemical Formula 2.

p[Li₂MnO₃]·(1−p)[Li_{q}JO₂] [Chemical Formula 2]

In Chemical Formula 2, 0≤p≤1, 0.9≤q≤1.2, and J may include at least one element from Mn, Ni, Co, Fe, Cr, V, Cu, Zn, Ti, Al, Mg and B.

For example, a cathode slurry may be prepared by mixing the cathode active material in a solvent. The cathode slurry may be coated on the cathode current collector 105, and then dried and pressed to prepare the cathode active material layer 105.

The cathode active material layer 110 may further include a binder, and optionally may further include a conductive material, a thickener, etc.

Materials substantially the same as or similar to the above-described binder/conductive material may be used as the binder and conductive material for a cathode. In some embodiments, a PVDF-based binder may be used as the cathode binder.

The separator 140 may include a porous polymer film or a porous non-woven fabric. The porous polymer film may include a polyolefin-based polymer such as an ethylene polymer, a propylene polymer, an ethylene/butene copolymer, an ethylene/hexene copolymer, an ethylene/methacrylate copolymer, etc. The porous non-woven fabric may include a high melting point glass fiber, a polyethylene terephthalate fiber, etc.

The separator 140 may include a ceramic-based material. For example, inorganic particles may be coated on the polymer film or dispersed in the polymer film to improve a heat resistance.

In example embodiments, an electrode cell may be defined by the cathode 100, the anode 130 and the separator 140, and a plurality of the electrode cells may be repeatedly arranged to form an electrode assembly 150. In some embodiments, the electrode assembly 150 may be a winding type, a stack type, a z-folding type, or a stack-folding type.

The electrode assembly 150 may be accommodated within a case 160 together with an electrolyte solution to define a lithium secondary battery. In example embodiments, a non-aqueous electrolyte solution may be used as the electrolyte solution.

The non-aqueous electrolyte solution may include a lithium salt as an electrolyte and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), diethyl carbonate (DEC), dimethyl carbonate (DMC), ethyl methyl carbonate (EMC), methylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, tetrahydrofuran, etc. These may be used alone or in a combination of two or more therefrom.

In some embodiments, a solid electrolyte may be used instead of the non-aqueous electrolyte solution described above. In this case, the lithium secondary battery may be fabricated in the form of an all-solid-state battery. Additionally, a solid electrolyte layer may be disposed between the cathode and the anode instead of the above-described separator.

The solid electrolyte may include a sulfide-based electrolyte. Non-limiting examples of the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, and Z is Ge, Zn or Ga), Li₂S—GeS₂, Li₂S—SiS₂—Li₃PO₄, Li₂S—SiS₂—LiₚMO_{q}, (p and q are positive numbers, M is P, Si, Ge, B, Al, Ga or In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), etc. These may be used alone or in a combination thereof.

In an embodiment, the solid electrolyte may include, e.g., an oxide-based amorphous solid electrolyte such as Li₂O—B₂O₃—P₂O₅, Li₂O—SiO₂, Li₂O—B₂O₃, Li₂O—B₂O₃—ZnO, etc.

As illustrated in FIG. 6, electrode tabs (a cathode tab and an anode tab) included in each electrode cell may protrude from the cathode current collector 105 and the anode current collector 125 to one side of the case 160. The electrode tabs may be welded together with the one side of the case 160 to be connected to an electrode lead (a cathode lead 107 and an anode lead 127) that may be extended or exposed to an outside of the case 160.

In FIG. 6, the cathode lead 107 and the anode lead 127 are illustrated as protruding from an upper side of the case 160 in a plan view, but the positions of the electrode leads are not limited thereto. For example, the electrode leads may protrude from at least one of two lateral sides of the case 160, and may also protrude from a lower side of the case 160. The cathode lead 107 and the anode lead 127 may be formed to protrude from different sides of the case 160.

For example, the case 160 may include a pouch-type case, a prismatic case, a coin-type case, etc.

The lithium secondary battery may be fabricated in a cylindrical shape using a can, a prismatic shape, a pouch shape, a coin shape, etc.

Hereinafter, embodiments of the present disclosure are described in more detail with reference to experimental examples. However, the following examples are only given for illustrating the present invention and those skilled in the related art will obviously understand that various alterations and modifications are possible within the scope and spirit of the present invention. Such alterations and modifications are duly included in the appended claims.

### EXAMPLE

A first mixture was prepared by dry-mixing artificial graphite and a CMC powder (a CMC content: 0.6 wt %). A second mixture in a powder form was prepared by wet-mixing natural graphite and an SBR solution (an SBR content: 3.5 wt %).

A third mixture was prepared by dry-mixing the first mixture, the second mixture, and graphite as a conductive material. A weight ratio of the first mixture and the second mixture was adjusted to 1:1.

A slurry-type anode composition having a solid content of 57 wt % was prepared by mixing and stirring the third mixture with a CMC solution. A weight ratio of the anode active material (artificial graphite and natural graphite), SBR, CMC and the conductive material in the solid content of the anode composition was adjusted to 95:1.5:1.2:2.3.

Each of the first to third mixtures was prepared by stirring at a speed of 80 rpm for 20 minutes using a planetary mixer. The anode composition was prepared by stirring at a speed of 2,000 rpm for 60 minutes using a high viscosity mixer.

### COMPARATIVE EXAMPLE

As described with reference to FIG. 2, artificial graphite, natural graphite, the conductive material and a CMC aqueous solution were mixed to prepare a first slurry, and then a CMC solution was additionally added to prepare a second slurry. The second slurry was mixed with an SBR aqueous solution to prepare an anode composition. A solid content of the anode composition and a weight ratio of the anode active material, CMC, SBR and the conductive material were adjusted were the same as those in Example 1.

### Experimental Example

### (1) Measurement of Viscosity

A viscosity of each anode composition of Example and Comparative Example was measured using a rheometer from NETZSCH (flat spindle, torque 1 Nm-250 Nm, shear rate 0.1/s˜100/s, 25° C.).

### (2) Measurement of Adhesive Force

Each anode composition of Example and Comparative Example were applied to a surface of an anode current collector (Cu foil, thickness: 8 μm) with a thickness of 110 m, and then dried and pressed under the same conditions to obtain an anode including an anode active material layer having an electrode density of 1.3 g/cm³.

The anode was cut into a size of 1.8 cm×10 cm to form an anode sample, and then the anode sample was fixed to a slide glass using a double-sided tape. Scotch Magic Tape (3M) was attached to a surface of the anode active material layer, and an adhesive force for being peeled off from the anode current collector was measured when being pulled at a rate of 100 mm/min by 90° using a UTM (TA product).

The evaluation results are shown in Table 1 below.

TABLE 1

| | viscosity of | |
|---|---|---|
| | composition | adhesive force |
| | Pa · s | (N/cm) |
| Example | 32.2 | 0.22 |
| Comparative | 31.2 | 0.19 |
| Example | | |

Referring to Table 1, in Example where artificial graphite and natural graphite were pre-mixed using different binders and then re-mixed to prepare the anode composition, increased adhesive strength was provided while maintaining a similar level of a viscosity compared to that from Comparative Example.

What is claimed is:

1. A method of preparing an anode composition, comprising:
mixing a first graphite-based active material and a first binder to form a first mixture;
mixing a second graphite-based active material different from the first graphite-based with a second binder different from the first binder to form a second mixture; and
mixing the first mixture and the second mixture to form an anode composition.

2. The method of claim 1, wherein the first graphite-based active material comprises artificial graphite, and the second graphite-based active material comprises natural graphite.

3. The method of claim 2, wherein the first binder comprises a cellulose-based binder, and the second binder comprises a butadiene rubber-based binder.

4. The method of claim 3, wherein the first binder comprises carboxymethyl cellulose (CMC) and the second binder comprises styrene-butadiene rubber (SBR).

5. The method of claim 3, wherein the formation of the first mixture comprises dry-mixing the first graphite-based active material and a powder of the first binder.

6. The method of claim 3, wherein the formation of the second mixture comprises mixing the second graphite-based active material and a solution of the second binder.

7. The method of claim 3, wherein a content of the first binder is in a range from 0.1 wt % to 2 wt % based on a total weight of the first mixture.

8. The method of claim 3, wherein a content of the second binder is 1 wt % to 7 wt % based on a total weight of the second mixture.

9. The method of claim 1, wherein the formation of the anode composition further comprises:
mixing the first mixture, the second mixture and a conductive material to form a third mixture; and
mixing the third mixture with a solution of the first binder.

10. The method of claim 9, wherein the third mixture comprises dry-mixing the first mixture, the second mixture and the conductive material, each of which has a powder form.

11. The method of claim 10, wherein the second mixture has a powder form having an increased liquid content compared to that of the first mixture.

12. The method of claim 11, wherein the third mixture has a powder form having a reduced liquid content compared to that of the second mixture.

13. The method of claim 1, wherein a solid content of the anode composition is in a range from 40 wt % to 70 wt %.

14. The method of claim 1, wherein a viscosity of the anode composition is in a range from 20 Pa·s to 40 Pa·s at 25° C.

15. A method for fabricating an anode, comprising:
coating the anode composition prepared according to claim 1 on an anode current collector; and
drying and pressing the coated anode composition to form an anode active material layer.

16. The method of claim 15, wherein an adhesive force between the anode current collector and the anode active material layer is 0.1 N/cm or more.

17. The method of claim 15, wherein an adhesive force between the anode current collector and the anode active material layer is in a range from 0.15 N/cm to 0.5 N/cm.

18. A method for manufacturing a lithium secondary battery, comprising:
fabricating an anode according to claim 15;
fabricating a cathode; and
repeatedly stacking the cathode and the anode.

19. The method of claim 18, wherein the anode active material layer of the anode comprises artificial graphite and natural graphite as a graphite-based active material, and comprises a cellulose-based binder and a butadiene rubber-based binder as a binder.
